(19) United States
(12) Patent Application Publication
(10) Pub. No.: US 2013/0188526 A1
(43) Pub. Date: Jul. 25, 2013

(54) SYSTEMS AND METHODS FOR ENABLING ACCESS TO EMERGENCY SERVICES

(71) Applicants: Steven Lee Cooper, JR., Whitestown, IN (US); Jeffrey William Speicher, Sheridan, IN (US)

(72) Inventors: Steven Lee Cooper, JR., Whitestown, IN (US); Jeffrey William Speicher, Sheridan, IN (US)

(73) Assignee: THOMSON LICENSING, Issy de Moulineaux (FR)

(21) Appl. No.: 13/876,009

(22) PCT Filed: Oct. 14, 2010
(86) PCT No.: PCT/US2010/002766

§ 371 Date: Mar. 26, 2013

(51) Int. Cl. H04M 3/51; H04M 1/253

(52) U.S. Cl. CPC H04M 3/5116; H04M 1/2535
USPC 370/259

(57) ABSTRACT

Systems and methods for providing a user with access to emergency services are described. A cable modem/multimedia terminal adapter employing voice over internet protocol (VoIP) can be configured to provide access to emergency services during periods of unavailability of a connection to a network due to software upgrades of the cable modem/multimedia terminal adapter or a VoIP handset, a power outage or a malfunction of the cable modem/multi-media terminal adapter or the VoIP handset. Access to emergency services can be provided through the use of a dedicated button on the cable modem/multimedia terminal adapter and the use of dedicated hardware in the cable modem/multimedia terminal adapter that is configured to initiate operation when a connection to the network is unavailable.

### BACKGROUND

In recent years, alternatives to traditional telephone services have become commercially viable and popular due to the ability to provide these alternatives at a relatively low cost. A Voice over Internet Protocol (VoIP) system is one such example. VoIP enables cable service providers to use their existing networks and much of their existing equipment to provide a telephone service of acceptable quality to their customers. In particular, voice communications are transmitted over internet protocol (IP) networks, such as the Internet or other packet switched networks, in lieu of or in combination with a public switched telephone network. Typically, a VoIP telephone call is implemented by converting an analog voice signal from a telephone to a digital format and compressing or translating the signal into IP packets for transmission over an IP network. Conversely, received voice communication signals are decompressed or translated from IP packets and converted into analog voice signals that are provided to a user's telephone.

### SUMMARY

While the quality of alternative communication services is comparable to traditional telephone services, alternative communication services can be unreliable for a variety of reasons. In particular, a connection to a network within an alternative communication system can be unavailable during certain periods, which can prevent a user from contacting emergency service providers during an emergency. The present principles provide a variety of methods and systems for enabling a user to contact emergency services via a communication system during periods of network connection unavailability.

One exemplary implementation is directed to a network communication system. The system can include a user-interface that is configured to receive an indication of an emergency event. In addition, the system can further include a network interface for connecting the system to a network. Moreover, the system can comprise a controller that is configured to determine the availability of a network connection, to record that the indication was received when a connection to the network is unavailable and to direct the network interface to transmit a message indicating that the emergency event has occurred in response to determining that the connection has become available.

Another exemplary implementation is directed to a method in which an indication of an emergency event can be received. The method can further include recording that the indication was received when a connection to a network is unavailable. In addition, in response to determining that the connection has become available, a message indicating that the emergency event has occurred can be transmitted through the network.

An alternative exemplary implementation is directed to a system including a telephone handset and a network terminal. Here, the network terminal can be configured to connect the telephone handset to a network and to enable communications using voice over Internet protocol. The network terminal can further include a user-interface and a controller. The user-interface can be configured to receive an indication of an emergency event as an alternative to receiving the indication via the telephone handset if communication capability via the telephone handset is unavailable. In turn, the controller can be configured to direct the terminal to transmit, over the network, a message indicating that the emergency event has occurred.

Another exemplary implementation is directed to a method. In the method, a plurality of calls can be serviced in accordance with a maximum-lines-in-use constraint. In addition, the method can further include determining that a user is attempting to contact an emergency service provider while the number of calls serviced is at the maximum-lines-in-use constraint. Further, one of the calls serviced can be disconnected and the user can be provided with an open connection to contact the emergency service provider.

### BRIEF DESCRIPTION OF THE DRAWINGS

The embodiments can be readily understood by considering the following detailed description in conjunction with the accompanying drawings, in which:

FIG. 1 is a block/flow diagram of an implementation of a Voice Over Internet Protocol network.

FIG. 2 is a block/flow diagram of an implementation of a network communication system for providing a user access to emergency services.

FIG. 3 is a flow diagram of an implementation of a method for providing a user access to emergency services.

FIG. 4 is a flow diagram of an implementation of an alternative method for providing a user access to emergency services.

It should be understood that the drawings are for purposes of illustrating the concepts and are not necessarily the only possible configuration for illustrating embodiments. To facilitate understanding, identical reference numerals have been used, where possible, to designate identical elements that are common to the figures.

### DETAILED DESCRIPTION

Voice over Internet Protocol (VoIP) phone systems can be less reliable than land-line, analog Plain Old Telephone Services (POTS), which, in contrast, are extremely reliable by design. The reliability of POTS is due to such features as dedicated phone lines and power supplies. Thus, even if household power is unavailable, the POTS still has the ability to function. With newer VoIP systems, there are a number of potential problems that can prevent a user from being able to make phone calls. For example, power failures, communication failures with handsets, software failures and downtime during system upgrades are all potential problems that can prevent a user from making phone calls. In particular, any one or more of these problems can result in a user being unable to contact emergency services by dialing 9-1-1. Thus, access to emergency services, such as 911 services, can be less reliable on a VoIP system as compared to a POTS system.

To address these problems, the present principles provide systems and methods for improving the reliability of access to 9-1-1 emergency services when a connection to a network is unavailable. For example, the unavailability can stem from inoperable handsets or Multimedia Terminal Adapter (MTA) problems in addition to other potential problems, as discussed above. In exemplary implementations, the reliability of the VoIP emergency service can be improved by adding additional features to the Cable Modem (CM) and MTA. As discussed in further detail herein below, examples of additional features can include a dedicated emergency button on the base unit of the MTA, special circuits to monitor for emergency events, the usage of non-volatile storage to record emergency events for later use or retries and additional backup batteries dedicated to supplying power only in the presence of an emergency event.

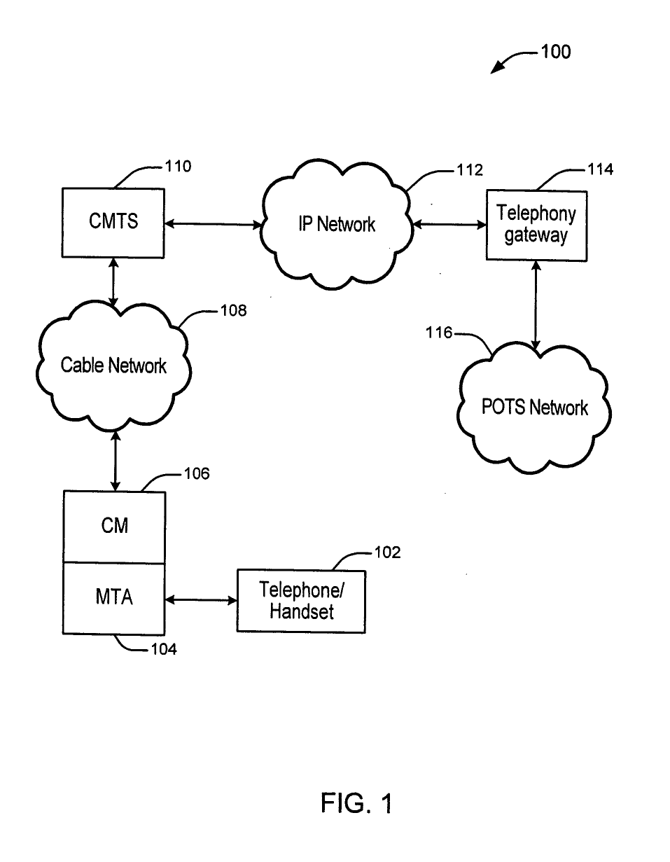

Referring now in specific detail to the drawings in which like reference numerals identify similar or identical elements throughout the several views, and initially to FIG. 1, an exemplary system 100 for implementing embodiments of the present principles is illustrated. System 100 can include a telephone or telephone handset 102 that is connected to and is in signal communication with an MTA 104. The telephone/handset 102 can be a VoIP handset. The MTA 104 can be connected to and can be in signal communication with a cable modem (CM) 106 to enable the telephone/handset 102 to access a cable network 108 using VoIP. It should be noted that the MTA 104 and the cable modem 106 can be separate units or can be integrated in a single unit. The system 100 can further include a Cable Modem Termination System (CMTS) 110 (commonly referred to as a cable head-end) that can be in the local cable network 108 and can be configured to act as an interface between the local cable network 108 of a service provider and an IP network 112, such as the internet. In turn, the CMTS 110 can be connected to a telephony gateway 114 on the IP network 112 to provide access to a POTS network 116, such as a Public Switch Telephone Network (PSTN). Here, the MTA 104 can, for example, be configured to convert between analog voice signals and IP packetized voice signals while the telephony gateway 114 can, for example, be configured to convert between IP packetized voice and standard pulse code modulated signals for the POTS network 116.

Embodiments of the present principles discussed herein below can be implemented within the CM 106/MTA 104 to provide a user with reliable access to emergency services. For example, as indicated above, failures due to communication problems with handsets can result from a number of sources. One such source can originate in the telephone/handset 102. For example, the handset can be wireless and the batteries powering the handset can lose their charge. In addition, there can also be radio interference between the handset and the MTA 104 or its base station connected to the MTA 104, thereby rendering a connection to the network 108 unavailable via the handset. Alternatively, the unavailability can be due to a faulty connection of an analog phone 102 to a subscriber line interface circuit (SLIC) interface. Further, the handset can be unusable because it is in the middle of a firmware upgrade.

For these cases of unavailability, a reliable interface can be added on the base unit of the CM 106/MTA 104 such as a button to enable a user to connect to emergency services. In addition, this button can be connected to the MTA 104 via a cable of any desirable length to enable the user to place it where the user can more easily access the button.

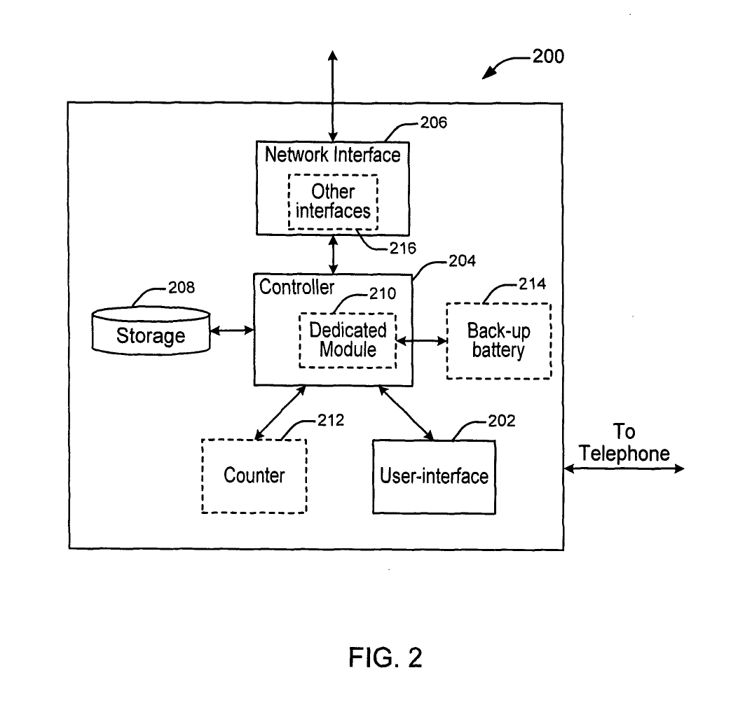

With reference now to FIG. 2 with continuing reference to FIG. 1, a network communication/network terminal system 200 for providing a user with access to emergency services according to an embodiment of the present principles is illustrated. System 200 can be implemented as a CM 106/MTA 104 discussed above. For example, the CM 106 can include the network interface 206 to connect the system 200 to the cable network 108. In addition, the MTA 104 can include the user-interface 202, which can be implemented as the button enabling a user to connect to emergency services, as discussed above, and/or can be implemented as an interface to the telephone/handset 102. Further, the other elements illustrated in FIG. 2 can be implemented in one or more of the CM 106 and the MTA 104.

If the user-interface 202 is implemented as a button, when selected, the button can trigger the system 200 to automatically open a Network-based Call Signaling (NCS)/Media Gateway Control Protocol (MGCP) connection to a Call Management Server (CMS) running at the CMTS 110, and perform a 911 call. After the call has been connected, a pre-recorded message stored in a storage medium 108, which can be implemented as non-volatile memory, can be played. For example, a pre-recorded message can be stored in non-volatile memory in the G.711 audio format for transmission via the Real-time Transport Protocol (RTP) to the CMS. This pre-recorded message can be included in the firmware image for the system 200 and can include a basic message such as “Emergency assistance is needed.” In addition, the system 200 can provide a means of permitting the user to record a personalized message of sufficient duration to permit the message to include the user's name, address and any additional pertinent information. The recording of this message can be made by the user by using telephone/handset 102, which can be a VoIP handset.

Another situation that can render a connection to network 108 unavailable is a software upgrade of system 200 or an MTA portion of system 200. For example, during parts of this upgrade process, one or more portions of system 200, such as the MTA 104, can be unavailable, which can prevent calls from being made and can also prevent communication with or via telephones/handsets 102. In this case, even if a dedicated button on the base unit is provided, it may not be possible for the user to contact emergency services. Thus, exemplary implementations of the present principles described herein below can provide a variety of solutions to this problem.

One solution is to provide a means in the software upgrade to prevent or greatly reduce downtime during the software upgrade. This can be done by the use of additional nonvolatile storage and RAM that can be implemented in the storage medium 108 so that two MTA images can be stored and can run simultaneously via the control of controller 212. Then, after the new MTA executable has been started, the controller 204 can direct the hand-off from the old MTA image to the new, upgraded MTA image when there is no user interaction with the system. In other words, the system 200 can be configured such that switchover would not occur until no calls were in progress.

In accordance with an alternative solution, if it is undesirable to architect the software to provide the dual MTA solution, a CM portion of the system 200 can be configured to maintain knowledge of the MTA status and to monitor the connection to the emergency services button. Then, if the button is selected while a portion of the system 200, such as an MTA portion, is unavailable, the CM can record the event in non-volatile storage. For example, the controller 204 can be implemented in a CM, can be configured to monitor the software status of other portions of system 200, such as an MTA portion, and can be configured to monitor the user-interface 202 to determine whether the interface 202 has been selected by the user. When the portion of the system that is being upgraded becomes available, that portion can either detect the event in storage or be notified by the controller 204, which can be implemented in the CM, when the portion status is correct or upgraded.

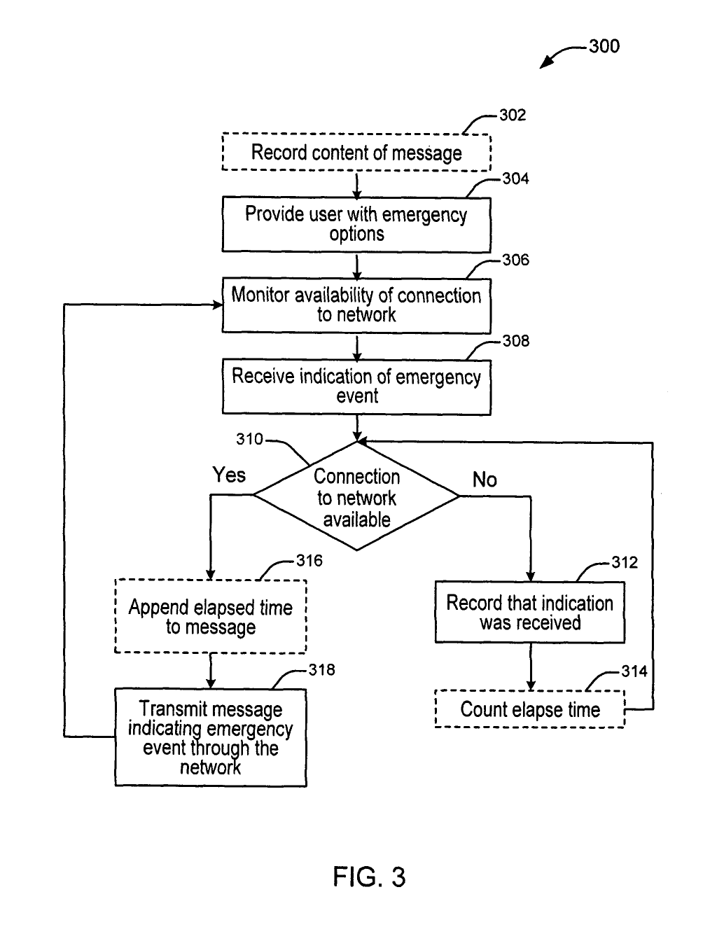

Referring now to FIG. 3, with continuing reference to FIGS. 1 and 2, an exemplary method 300 for providing access to emergency services is illustrated. It should be understood that any and all aspects discussed above with regard to system 200 can be implemented in method 300. The method 300 can, optionally, begin at 302, in which the system 200 can record the content of an emergency message. For example, as discussed above, a user can employ the telephone/handset 102 to pre-record a message detailing a user's name, address and any additional pertinent information. Alternatively, the system 200 can be pre-configured to have a standard message, such as “Emergency services are needed.” In addition, based on information that a user provides in a profile report prior to contracting services with a cable service provider, the system 200 can be pre-configured to include the pertinent personal information about the user in the stored message before the system 200 is installed on the user's premises.

At step 304, the system 200 can provide a user with one or more emergency options. For example, the system 200 can include a plurality of dedicated interfaces within user interface 202, such as buttons, each of which can be dedicated to one or more of fire, medical, or police services, or any other appropriate emergency service. The system 200 can also provide the user with a single option, corresponding to a general 9-1-1 service. In addition, the user-interface 202 can be connected to other devices or dedicated emergency service provider networks such as a fire alarm device or network, medical alert systems or an alarm system used for detecting break-ins. The connections to the other devices or dedicated emergency service provider networks can be implemented through the optional other interfaces 216 illustrated in FIG. 2 for transmission of the message indicating that an emergency event has occurred through one or more of the dedicated emergency service provider networks.

At step 306, the controller 204 can monitor the availability of a connection to the network 108. For example, as discussed above, the controller 204 can be configured to periodically monitor the software status of one or more portions of system 200, the upgrade of which can render the connection to the network 108 unavailable. Additionally or alternatively, the controller 204 can be configured to monitor whether a power failure has occurred, where the system 200's main power supply is cut off and/or whether a software failure in the system 200 has occurred.

At step 308, the system 200 can receive an indication of an emergency event. For example, as discussed above, the system 200 can receive the indication of the emergency event via one or more dedicated buttons in the user-interface 202 that can be monitored by the controller 204. Alternatively or additionally, the system 200 can receive the indication of the emergency event via the telephone/handset 102 through the user-interface 202.

Based on the monitoring step 306, at step 310, the controller 204 can determine whether a connection to the network 108 is available.

If a connection to the network 108 is unavailable for reasons discussed above, then the method can proceed to step 312, in which the controller 204 can record that the indication was received or direct the recordation of any received indications. For example, as discussed above, the controller 204 can record the event in non-volatile memory of storage medium 208.

Optionally, at step 314, an optional counter 212 in system 200 can be configured to count the elapsed time from receiving the indication. Here, the elapsed time can be a rough estimate of how long ago the emergency option was selected or how long ago the indication of the emergency event was received. Thereafter, the method can proceed to step 310, wherein the controller 204 can periodically and repeatedly determine whether the connection to the network has become available.

If a connection to the network 108 is available, then the method can optionally proceed to step 316, in which the controller 204 can append the elapsed time to the emergency message. For example, the controller 204 can poll the counter 212 just prior to transmitting the message across the network 108 and can append the elapsed time to the message.

In addition, if a connection to the network 108 is or becomes available, at step 318, the controller 204 can direct the transmission of the message indicating that the emergency event has occurred through the network 108 via the network interface 206. Thereafter, the method can proceed to step 306 and can be repeated. As indicated above, the pre-recorded or pre-configured message can be sent via an NCS/MGCP connection to the CMTS 110, which in turn can enable the system 200 to call an emergency service provider and replay the pre-recorded or pre-configured message. Alternatively, due to the complexity of opening a connection with the CMS, either through NCS, MGCP, Session Initiation Protocol (SIP), RTP or any other protocol, the standards for any or all of those protocols can be extended to provide a special emergency services event (ESE). This ESE can be a specialized protocol extension that can act as the emergency message. The provider of the CMS can provide an additional service to monitor for these ESEs and either contact the appropriate emergency services using a live operator or some automated system of the provider's choosing. It should be understood that the emergency message can include a request for emergency assistance, or can additionally include vital user information. Such personal information about the user can include the user's address, age, medical condition, etc. In addition, an emergency service provider can be a medical service provider, a fire department, a police department, a poison control information service or any other type of emergency service provider.

In one potential scenario, it is possible that the CM itself can be in the process of a software upgrade. In this case, an optional dedicated executable, or special hardware, which can be implemented as a dedicated module 210 within the controller 210, can be configured to perform any one or more of steps 306-318 discussed above.

In another severe scenario, the system 200 can completely lose power and even a battery backup for the system 200 can be completely discharged. In this case, a dedicated emergency service circuit (ESC), which also can be implemented as the dedicated module 210, can be added to the system 200 with its own optional backup battery 214 to power the dedicated module 240. The dedicated module 210 can be configured to run in an extremely low power mode so as to be able to run for weeks using only the power from the emergency services back-up battery 210. If the indication of the emergency event is received, when, for example, a user selects a dedicated emergency services button, the event can be stored in the circuit or in the storage medium 208. Later, when power again becomes available to the system 200, a portion of the system 200, such as an MTA 104, can check the state of the ESC and perform the automatic call to emergency services if an emergency event is stored. Further, in exemplary embodiments, the ESC can include the counter 212, which can be employed to provide emergency services an indication of when the emergency event occurred, as discussed above.

According to other aspects, instead of relying on additional backup batteries, the system 200 can be configured to shut down operation before the battery or batteries have completely discharged. Thus, the cable gateway can shut down with an emergency power reserve of, for example, 5-10% battery power remaining. Then, if the emergency button is pressed, power can be re-enabled to make the automatic emergency call.

In one exemplary implementation, the controller 204 can perform step 306 and, if a connection to the network is unavailable, can automatically direct the dedicated module to initiate operation and perform steps 308-318 of the method 300. Further, at step 308, the dedicated module 210 can monitor the user-interface 202 to determine whether any indication of an emergency event has been received. After the dedicated module 210 determines that the connection has become available, it can power itself down.

According to other exemplary aspects, the system 200 can provide multiple phone line capabilities, but with a maximum number of lines in use limitation. For example, a family of four can request and be assigned four different phone numbers for their household. This example is equally application to a commercial service scenario, where four users at a location can request and be assigned four different phone numbers at the location. Here, the system 200 can have a maximum-lines-in-use constraint of three concurrent calls. If three of the users are utilizing three lines, respectively, and a fourth user attempts to make a call, the fourth user would ordinarily be presented with a “maximum-lines-in-use” message, and would be unable to make the call. However, this aspect is especially problematic when the fourth user is attempting to make a call to emergency service providers. According to exemplary embodiments, the system 200 can provide an emergency override in the maximum-lines-in-use message instructing the user on how to force the system 200 to drop one of the other calls in progress so that the line can be allocated to the emergency call. For example, the telephone/handset 102 and/or the user-interface 202 can include a button dedicated for the override or can be configured to receive and recognize a code entered by the user as instructed by the maximum-lines-in use message. Alternatively or additionally, the system 200 or the telephone/handset 102 can be configured to automatically recognize the dialing of “9-1-1” and automatically initiate the override of another call. For example, if the telephone/handset 102 recognizes the dialing for an emergency service, the telephone/handset 102 can communicate with the system 200 to free up a line. In turn, if the system 200 recognizes the dialing for an emergency service, the controller of system 200 can automatically drop one of the other calls to permit the user to call an emergency service provider.

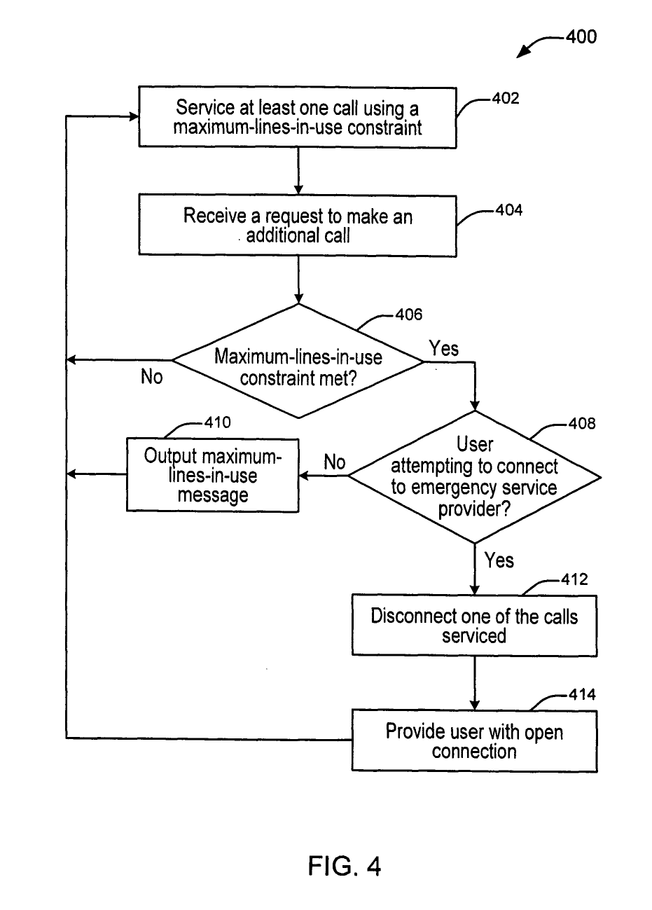

With reference now to FIG. 4, with continuing reference to FIG. 2, an exemplary method for providing access to emergency service providers is illustrated. Method 400 can begin at step 402 in which the system 200 can service at least one call in accordance with a maximum-lines-in-use constraint. As discussed above, the maximum-lines-in-use constraint limits the number of concurrent calls that can be serviced by the system 200.

At step 404, the system 200 or the telephone/handset 102 can receive a request to make an additional call. For example, the controller 204 or the telephone/handset 102 can detect that the handset 102 was either lifted off of the hook or powered on. Alternatively, the telephone/handset 102 can detect that a user is dialing a number. In addition, the controller 204 can receive a request to make an additional call by detecting that the telephone/handset 102 has requested a dial tone.

At step 406, the controller 204 or the telephone/handset 102 can determine whether the maximum-lines-in-use constraint is met. For example, the controller 204 or the telephone/handset 102 can compare the number of calls serviced in step 402 to the maximum-lines-in-use constraint. As indicated above, the maximum-lines-in-use constraint is the maximum number of concurrent calls that the system 200 can service.

If the number of calls serviced is below the maximum-lines-in-use constraint, then the method can proceed to step 402 in which the controller 204 services the additional call requested at step 404 in addition to any other calls still in progress. The method can thereafter be repeated.

If the number of calls serviced is at the maximum-lines-in-use constraint, then the controller 204 or the telephone/handset 102 can, at step 408, determine whether the user is attempting to connect to or contact an emergency service provider. For example, as indicated above, the controller 204 or the telephone/handset 102 can detect that the user is attempting to contact an emergency service provider by recognizing the telephone number the user has dialed. For example, if a user dials “9-1-1,” the controller 204 or the telephone/handset 102 can automatically determine that the call is for an emergency service. Alternatively, the controller 204 or the telephone/handset 102 can cross-reference a number dialed by the user with telephone numbers of emergency service provider included in a list of emergency service providers. The list can include separate local telephone numbers for, for example, a local police department, a local ambulance service, a local hospital, a local fire department, poison control services or any other emergency service provider. In accordance with other exemplary aspects, the controller 204 or the telephone/handset 102 can determine that a user is attempting to connect to or contact an emergency service provider by detecting that a dedicated button was selected or detecting that a code for a call override has been entered. For example, as indicated above, the code can be included in a maximum-lines-in-use message for the user. In this scenario, step 410 can be performed before step 408, where the controller 204 or the telephone/handset 102 can output a maximum-lines-in-use message including the override code.

If the controller 204 or the telephone/handset 102 determines that the user is not attempting to connect to an emergency service provider, then the controller 204 or the telephone/handset 102 can direct the system 200 to output a maximum-lines-in-use message at step 410 and prevent the user from making the call requested at step 404. The method can thereafter be repeated. Alternatively, if the maximum-lines-in-use message was output prior to step 408, then the controller 204 or the telephone/handset 102 can automatically prevent the user from making the call requested at step 404 and the method can thereafter be repeated.

If the controller 204 or the telephone/handset 102 determines that the user is attempting to connect to or contact an emergency service provider, then, at step 412, the controller 204 or the telephone/handset 102 can direct the system 200 to disconnect one of the calls serviced at step 402. Thereafter, the controller 204 or the telephone/handset 102 can, at step 414, direct the system 200 to provide the user with an open connection to contact the emergency service provider. The method can proceed to step 402, where the controller 204 can direct the system 200 to service the emergency call requested at step 404 in addition to any other calls still in progress. The method can thereafter be repeated.

Thus, in accordance with the exemplary methods and systems discussed herein, reliable access to emergency services can be provided in a variety of scenarios that would otherwise render connections to a communication network unavailable. In this way, alternative communication systems, such as VOIP systems, can ensure user-access to emergency services and thereby provide users with comparable reliability offered by conventional public switched networks.

It should be understood that the functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the embodiments. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

Having described preferred embodiments for systems and methods for providing access to emergency services (which are intended to be illustrative and not limiting), it is noted that modifications and variations can be made by persons skilled in the art in light of the above teachings. It is therefore to be understood that changes can be made in the particular embodiments disclosed which are within the scope as outlined by the appended claims. While the forgoing is directed to various embodiments, other and further embodiments can be devised without departing from the basic scope thereof.

1. A method, comprising:
recording receipt of an emergency event when a connection to a network is unavailable; and
transmitting a message indicating that the emergency event has occurred through the network in response to determining that the connection has become available.

2. The method of claim 1, further comprising:
counting elapsed time between receipt of the emergency event and transmitting the message; and
appending the elapsed time to the message.

3. The method of claim 1, further comprising:
recording content of the message prior to receipt of the emergency event, wherein the content is provided by a user.

4. The method of claim 1, wherein the message is a specialized extension of a protocol used to communicate on the network.

5. The method of claim 1, further comprising:
providing a user with options corresponding to different categories of emergency events, wherein the emergency event is received in accordance with a user-selected option.

6. The method of claim 1, wherein the message is a request for an emergency service that is at least one of a medical service, a fire response service or a police service.

7. The method of claim 6, wherein the message includes personal information about the user.

8. A network communication system comprising:
a network interface for connecting to a network; and
a controller connected to the network interface and configured to determine the availability of a network connection, to record receipt of an emergency event when a connection to the network is unavailable, and to direct the network interface to transmit a message indicating that the emergency event has occurred in response to determining that the connection has become available.

9. The system of claim 8, further comprising:
a user interface configured to receive an emergency event, wherein the user-interface includes an interface for connecting to a handset to enable voice communication through the network using voice over internet protocol and wherein unavailability of the connection to the network is due to a malfunction of the handset.

10. The system of claim 8, further comprising:
a counter configured to count elapsed time between receiving the emergency event and transmitting the message, wherein the controller is further configured to append the elapsed time to the message.

11. The system of claim 8, wherein the unavailability of the connection to the network is due to at least one of a software upgrade in the system, a power failure or a software failure.

12. The system of claim 8, further comprising:
non-volatile memory for storing the indication.

13. The system of claim 8, wherein the controller further comprises:
a dedicated module configured to activate operation in response to the unavailability of the network connection, to monitor the user-interface to determine whether any indication of an emergency event has been received, to direct recordation of any received indications and to direct the network interface to transmit the message.

14. The system of claim 13, further comprising:
a backup battery configured to power the dedicated module.

15. The system of claim 13, wherein the controller is implemented in at least one of a cable modem or a multi-media terminal adapter.

16. The system of claim 15, wherein the user-interface is at least one button dedicated for notifying emergency service-providers of the emergency event.

17. The system of claim 15, wherein the network interface further comprises interfaces to a plurality of dedicated emergency-service provider networks and wherein the message is transmitted on at least one of the dedicated emergency-service provider networks.

18. A system comprising:
a telephone handset; and
a network terminal configured to connect the telephone handset to a network and to enable communications using voice over interne protocol, the network terminal further comprising:
a user-interface configured to receive an indication of an emergency event as an alternative to receiving the indication via the telephone handset if communication capability via the telephone handset is unavailable, and
a controller configured to direct the terminal to transmit, over the network, a message indicating that the emergency event has occurred.

19. A method comprising:
servicing a plurality of calls in accordance with a maximum-lines-in-use constraint;
determining that at least one of the plurality of calls is for contacting at least one emergency service provider while a number of calls serviced is at the maximum-lines-in-use constraint;
disconnecting at least one of the calls serviced; and
opening at least one call connection to contact at least one emergency service provider.

20. The method of claim 19, wherein the determining further comprises cross-referencing a number dialed with a telephone number of an emergency service provider.
